(19) United States
(12) Patent Application Publication
(10) Pub. No.: US 2016/0351901 A1
(43) Pub. Date: Dec. 1, 2016

(54) NONAQUEOUS-ELECTROLYTE SECONDARY BATTERY

(71) Applicant: SANYO ELECTRIC CO., LTD., Daito-shi, Osaka (JP)

(72) Inventor: Motoharu Saito, Hyogo (JP)

(73) Assignee: SANYO ELECTRIC CO., LTD., Daito-shi, Osaka (JP)

(21) Appl. No.: 15/113,917

(22) PCT Filed: Jan. 8, 2015
(86) PCT No.: PCT/JP2015/000050

§ 371 Date: Jul. 25, 2016

(30) Foreign Application Priority Data
Jan. 31, 2014 (JP) 2014-017128

(51) Int. Cl. H01M 4/525; H01M 10/0525

(52) U.S. Cl. CPC H01M 4/525; H01M 10/0525; H01M 2004/028

(57) ABSTRACT

A nonagueous electrolyte secondary battery has a positive electrode including a positive electrode active material which contains as a main component a lithium composite oxide containing at least cobalt, the lithium composite oxide having a crystal structure belonging to the space group P6₃mc and categorized as an O2 structure. The BET specific surface area of the lithium composite oxide is less than 0.6 m²/g. In the nonaqueous electrolyte secondary battery, the charge cutoff potential of the positive electrode is higher than 4.5 V (vs. Li/Li⁺).

### TECHNICAL FIELD

The present invention relates to nonaqueous electrolyte secondary batteries.

### BACKGROUND ART

Lithium composite oxides which have a crystal structure belonging to the space group P6₃mc and categorized as an O2 structure (hereinafter, sometimes written as O2 oxides) are being studied as a candidate of positive electrode active materials of the next generation (see Non Patent Literature 1). The use of these lithium composite oxides as positive electrode active materials potentially provides excellent charge-discharge characteristics over materials actually used in current batteries such as LiCoO₂ which have a crystal structure belonging to the space group R-3m (an O3 structure). According to Non Patent Literature 1, charging and discharging are feasible even when about 80% of lithium in the oxide is extracted.

### CITATION LIST

### Non Patent Literature

NPL 1: Solid State Ionics 144 (2001) 263

### SUMMARY OF INVENTION

### Technical Problem

Nonaqueous electrolyte secondary batteries which use an O2 oxide as a positive electrode active material exhibit excellent initial charge efficiency provided that the charge cutoff potential of the positive electrode is not more than 4.5 V (vs. Li/Li⁺). There is, however, a problem in which the initial charge efficiency is significantly decreased when the charge cutoff potential is increased to above: 1.5 V (vs. Li/Li⁺).

O2 oxides are materials having structural stability even at a high charge potential and are therefore usable under high potential conditions such as when the charge: potential is set to above: 4.5 V (vs. Li/Li⁺). On the other hand, O3 oxides actually used in current batteries such as LiCoO₂ undergo an irreversible: phase change when subjected to a high charge potential. Thus, a low potential is a precondition to the use of such materials. That is, the problem described above is inherent to the O2 oxides.

### Solution to Problem

The present inventors have found that the decrease in initial charge efficiency at a high potential exceeding 4.5 V (vs. Li/Li⁺) becomes more marked with increasing temperature. Based on this finding, the present inventors have ascribed the above problem mainly to lithium being consumed by the chemical reaction with the electrolyte without returning to the original sites. In the course of studies to suppress the occurrence of the chemical reaction during initial charging, the present inventors attempted to reduce the surface area of an O2 oxide constituting the positive electrode active material. As a result, the present inventors were successful in improving the initial charge efficiency at a high potential by limiting the BET specific surface area of the O2 oxide to less than 0.6 m²/g.

A nonaqueous electrolyte secondary battery according to the present invention includes a positive electrode active material which includes as a main component a lithium composite oxide containing at least cobalt, the lithium composite oxide having a crystal structure belonging to the space group P6₃mc and categorized as an O2 structure, the BET specific surface area of the lithium composite oxide being less than 0.6 m²/g, the charge cutoff potential of a positive electrode being higher than 4.5 V (vs. Li/Li⁺).

### Advantageous Effects of Invention

The nonaqueous electrolyte secondary battery according to the present invention includes a lithium compositeoxide as a positive electrode active Material: which has a crystal structure belonging to the space group P6₃mc and categorized as an O2 structure, and can achieve high initial charge efficiency even when the charge cutoff potential of the positive electrode is set to above 4.5 V (vs. Li/Li⁺).

### BRIEF DESCRIPTION OF DRAWINGS

FIG. 1 is a diagram illustrating a powder X-ray diffraction pattern of a lithium composite oxide (a positive electrode active material) prepared in EXAMPLE 1.

FIG. 2 is a view schematically illustrating a test cell fabricated in each of EXAMPLES and COMPARATIVE EXAMPLES.

FIG. 3 is a diagram illustrating relationships between the BET specific surface area and the initial charge-discharge efficiency of test cells fabricated in EXAMPLES and COMPARATIVE EXAMPLES.

### DESCRIPTION OF EMBODIMENTS

Hereinbelow, an example of the embodiments of the present invention will he described in detail.

In an exemplary embodiment of the present invention, the nonaqueous electrolyte secondary battery includes positive electrode, a negative electrode and a nonaqueous electrolyte. A separator is preferably disposed between the positive electrode and the negative electrode. For example, the nonaqueous electrolyte secondary battery has a structure in which the positive electrode and the negative electrode are wound via a separator and the wound electrode assembly and the nonaqueous electrolyte are accommodated in an exterior case-instead of such a wound electrode assembly, other forms of electrode assemblies may be adopted such as a stacked electrode: assembly in which the positive electrode and the negative electrode are stacked one on top of the other via a separator. The shapes of the nonaqueous electrolyte secondary batteries are not particularly limited, and examples thereof include cylindrical types, square types, coin types, button types and laminate types.

[Positive Electrodes]

For example, the positive electrode is composed of a positive electrode current collector such as a metal foil, and a positive electrode active material layer disposed on the positive electrode current collector. Examples of the positive electrode current collectors include foils of metals such as aluminum that are stable at positive electrode potentials, and films having such metals as skin layers. The positive electrode active material layer preferably includes a conductive material and a binder in addition to a positive electrode active material.

The conductive material is used to enhance the electric conductivity of the positive electrode active material layer. Examples of the conductive materials include carbon materials such as carbon black, acetylene black Ketjen black and graphite. These materials may be used singly, or two or more may be used in combination. The content of the conductive material is preferably 0.1 to 30 wt %, more preferably 0.1 to 20 wt %, and particularly preferably 0.1 to 10 wt % relative to the to mass of the positive electrode active material layer.

The binder is used to maintain a good contact between the positive electrode active material and the conductive material and also to increase the adhesion of the components such as the positive electrode active material with respect to the surface of the positive electrode current collector. Examples of the binders include polytetrafluoroethylene (PTFE), polyvinylidene fluoride, polyvinyl acetate, polymethacrylate, polyacrylate, polyacrylonitrile, polyvinyl alcohol and mixtures of two or more of these compounds. The binder may be used in combination with a thickener such as carboxymethyl cellulose (CMC) or polyethylene oxide (PEO). These materials may be used singly, or two or more may be used in combination. The content of the binder is /preferably 0.1 to 30 wt %, more preferably 0.1 to 20 wt %, and particularly preferably 0.1 to 10 wt % relative to the total mass of the positive electrode active material layer.

The positive electrode potential in a fully charged state of the positive electrode, namely, the cutoff potential at which the charging of the positive electrode is terminated is above 4.5 V (vs. Li/Li⁺). From the point of view of aspects such as increasing the capacity, the charge cutoff potential of the positive electrode is preferably not less than 4.6 V (vs. Li/Li⁺), and more preferably not less than 4.65 V (vs. Li/Li⁺). Although the upper limit of the charge cutoff potential of the positive electrode is not particularly limited, the charge cutoff potential is preferably not more than 5.0 V (vs. Li/Li⁺) from the point of view of aspects such as the prevention of the decomposition of the nonaqueous electrolyte.

Hereinbelow, the positive electrode active materials will be described in detail.

The positive electrode active material includes a lithium composite : oxide as a Main comPanent which has a crystal structure belonging to the space group P6₃mc and categorized as an 02. structure. Here, the O2 structure is such that a little atom is present at the center of oxygen octahedron, and oxygen and the metal oxide overlap in two different ways in the unit lattice. The BET specific surface area of the lithium composite oxide is less than 0.6 m²g.

Hereinafter, the lithium composite oxide: will be written as the “lithium composite oxide A”.

The positive electrode active material may include other metal compounds in the form of a mixture or a solid solution. Some of such additional metal compounds are those compounds having a different composition from the lithium composite oxide A, and those compounds belonging to a space group different from the space group P6₃mc, it is, however, preferable that the lithium composite oxide A be present in not less than 50 vol %, and more preferably not less than 70 vol % relative to the total volume of the positive electrode active material in the present embodiment, the positive electrode active material is composed solely of the lithium composite oxide A (100 vol %)

Examples of the above additional metal compounds /include LiCoO₂ belonging to the space group R-3m, Li₂MnO₂ belonging to the space group C2/m or C2/c, compounds resulting from partial substitution of manganese in Li₂MnO₃ by other metal elements, and a solide solution of Li₂mO₃ and Li _{1.2}Mn_{0.54}Ni_{0.13}Co_{0.13}O. Examples further include metal compounds which have an O3 structure or an 06 structure belonging to R-3m, and metal compounds which have a T2 structure belonging to the space group Cmca. The surface of the particles of the positive electrode active material (the lithium composite oxide: A) may have fine particles of inorganic compounds, for example, oxides such as aluminum oxide (Al₂O₃) and lanthanoid-containinq compounds.

The lithium composite oxide A contains at least Co, and preferably contains Co and Na. The lithium composite oxide A is preferably represented by the general formula: LiₓNa_{y}CoₓM_{(i-z)}O_{(2±y)} (0.75<x<1.1, 0<y<0.1, 0.8<z<0.98, 0≦γ<0.1, and N is at least one metal element (except Li, Na and Co)).

More preferably, the lithium composite oxide A contains at least Mn in addition to Co and Na. The lithium composite: oxide A is more preferably represented by the general formula: LiₓNa_{y}Co_{z1}Mn_{z2}M_{(1-z1-z2)}O_{(w±y) (}0.75<x<1.1, 0<y<0.1, 0.8<z1≦0.98, 0<z2<0.2, 0≦γ<0.1, and M is at least one metal element. (except. Li, Na, Co and Mn)).

In the specification, the composition of the lithium composite oxide -A represents the proportions in the discharged state. If the proportion x of Li is 1.1 or More, lithium enters into transition metal sites and the capacity density tends to he decreased.

As described above, the lithium composite oxide preferably contains a certain amount of Na. Specifically, the crystal structure of the lithium composite oxide A is stabilized and the battery performance (for example, cycle characteristics) is enhanced by limiting the proportion y of Na to less than 0.1, and more preferably to 0.02 or less. If the proportion y of Na is higher than 0.1, the crystal structure tends to be broken by the intercalation and deintercalation of Na and the oxide absorbs more water and may change its structure. When y≦0.02, powder X-ray diffractometry sometimes fail to detect Na.

Examples of the metal elements M present in the lithium composite oxide A besides Mn include Ni, Al, Mg, Ti, Bi, Zr, Fe, Cr, Mo, V, Ce, K, Ga and Tn. Of these metal elements, Ni and Ti are preferable, and Ni is particularly preferable.

The PET specific surface area of the lithium composite oxide A is less than 0.6 m²/g. This configuration suppresses the chemical reaction. of the surface of the lithium composite oxide A with the electrolytic solution and allows the battery to attain excellent initial charge-discharge efficiency even at a high charge potential exceeding 4.5 V (vs. Li/Li⁺). The lower limit, of the BET specific surface area is preferably 0.1 m²/g. By limiting the BET specific surface area of the lithium composite: oxide A to the range of 0.1 to less than 0.6m²/g, the initial charge-discharge efficiency at a high potential can be specifically improved without causing a decrease in properties such as battery capacity.

The BET specific surface area of the lithium composite oxide. A may be measured by a BET method tising a commercial nitrogen adsorption-desorption BET specific surface area analyzer.

The lithium composite oxide A May be by exchanging Na ions in a sodium composite oxide by Li ions. For example., the sodium composite oxide contains Li in a molar amount that does not exceed the molar amount of Na. The sodium composite oxide is preferably represented by LiₐNa_{b}C_{z1}Mn_{z2}M_{(1-z1-z2)}O_{(2±y)} (0≦a≦0.1, 0.65≦b≦1.0, 0.8<z1≦0.98, 0<z2≦0.2, 0≦γ<0.1, and M is at least one metal element (except Li, Na, CO and Mn)}.

Known as to Li ion exchange methods use water or an organic material as a solvent, or use a molten Li salt. Herein, the ion exchange was performed using water and lithium salts (for example, lithium hydroxide and lithium chloride) as the medium. The lithium composite oxide A prepared as described above contains a certain amount of residual Na due to the fact that the ion exchange: does not proceed completely.

### [Negative Electrodes]

For example, the negative electrode includes a negative electrode current collector such as a metal foil, and a negative electrode active material layer disposed on the negative electrode current collector. Examples of the negative electrode current collectors include foils of metals such as aluminum and copper that are stable at negative electrode potentials, and films having such metals as skin layers. The negative electrode active: material layer includes a negative: electrode active material capable of storing and releasing lithium ions, and preferably further includes a binder. The negative electrode active material layer may include a conductive material as required.

Examples of the negative electrode active materials include natural graphite, artificial graphite, lithium, silicon, carbon, tin, germanium, aluminum, lead, indium, gallium, lithium alloys, lithium-inserted carbon and silicon, and alloys and mixtures of these materials. The binder may be one similar to that used in the positive electrode such as PTFE, but is preferably other binder such as styrene-butadiene copolymer (SBR) or a modified product thereof. The binder may be used in combination with a thickener such as CMC.

### [Nonaqueous Electrolytes]

The nonaqueous electrolyte includes a nonaqueous solvent and an electrolyte salt dissolved in the nonaqueous solvent. The nonaqueous electrolytes are not limited to liquid electrolytes (nonaqueous electrolytic solutions), and may be solid electrolytes such as gelled polymer electrolytes. Examples of the nonaqueous solvents include esters, ethers, nitriles such as acetonitrile, amides such as dimethylformamide, and mixed solvents including two or more of these solvents.

Examples of the esters include cyclic carbonate esters such as ethylene carbonate, propylene carbonate and butylene carbonate, chain carbonate esters such as dimethyl carbonate, methyl ethyl carbonate, diethyl carbonate, methyl propyl carbonate, ethyl propyl carbonate and methyl isopropyl carbonate, and carboxylate esters such as methyl acetate, ethyl acetate, propyl acetate, methyl propionate, ethyl propionate and y-butyrolactone.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol and crown ethers, and chain ethers such as 1, -dimethoxyethane, diethyl ether, dipropyl ether, diisooropyl ether, dibutvl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dihutoxyethane, diethylene glycol dimethyl ether, diethylene glycol diethyl ether, diethylene glycol dibutyl ether, 1,1-dimethoxymethane, 1, l-diethoxyethane, triethylene glycol dimethyl ether and tetraethylene glycol dimethyl.

The nonaqueous solvent preferably includes a halogen substituted compound resulting from the substitution of hydrogen atoms in any of the above solvents by halogen atoms such as fluorine atoms. In particular, a fluorinated cyclic carbonate ester or a fluorinated chain carbonate ester is preferable, and more preferably both are Used as a mixture. With this configuration, food protective films are formed on the negative electrode and also on the positive electrode, And cycle characteristics are enhanced as a result. Preferred examples of the fluorinated cyclic carbonate esters include 4-fluoroethylene carbonate, 4,5-difluoroethylene carbonate, 4,4-difluoroethylene carbonate, 4,4,5-trifluoroethylene carbonate and 4,4,5,5-tetra fluoroethylene carbonate. Preferred examples of the fluorinated chain esters include ethyl 2,2,2-trifluoroacetate, methyl 3,3,3-trifluoropropionate and methyl pentafluoropropionate.

The electrolyte salt is preferably a lithium salt. Examples of the lithium salts include LiPF₆, LiEF₄, LiAsF₆, LiClO₄, LiCF₃SO₃, LiN(FSO₂)₂, LiN(C₁F₂₁₊₁SO₂) (CₘF₂ₘ₊₁So₂) (1 and m are integers of 1 or greater) , LiC(CₚF₂ₚ₊₁SO₂) (C_{q}E₂₊₁SO₂) (CᵣF₂ᵣ₊₁SO₂) (p, q and r are integers of 1 or greater) , Li [B (C₂O₄) ₂] (lithium bis oxalato) borate (LiBOB)) , Li [B (C₂O₄)F₂], Li[P (C₂O₄)F₄] and Li[P(C₂O₄)₂F₂]. The lithium salts may be used singly, or two or more may be used in combination.

### [Separators]

The separator may be a porous sheet having ion permeability and insulating properties. Specific examples of the porous sheets include MicroporouS thin films, woven fabrics and nonwoven fabrics. Examples of suitable separator materials include olefin resins such as polyethylene and polypropylene, and celluloses. The separator may be a stack having a cellulose fiber layer and a thermoplastic resin fiber layer such as an olefin resin.

### EXAMPLES

Hereinbelow, the present invention will be described in further detail based on EXAMPLES without limiting the scope: of the invention to such EXAMPLES.

### Example 1

### [Preparation of Lithium Composite Oxide Al (Positive Electrode Active Material)]

Sodium carbonate (NaCO₃), cobalt oxide (Co₃C)₄) and manganese: oxide (Mn₂O₃) were mixed together so that the stoichiometric ratio would be Mar The mixture was held at 900° C. for 10 hours to give a sodium composite oxide. The specific surface area of the sodium composite oxide was (0.09 m²/q) .

Lithium hydroxide (LiOH) and lithium chloride (LiCl) were mixed together in a molar ratio of 1:2. in water as a medium, mixture and the oxide wer.ibTi Othatiqed for 10 hours. During this process, the amount of Li was set to be times greater than the amount of Na in the sodium composite. oxide. In this manner, part of sodium in the sodium composite oxide was ion exchanged to lithium. The oxide was then washed with water. A lithium composite oxide. Al was thus obtained.

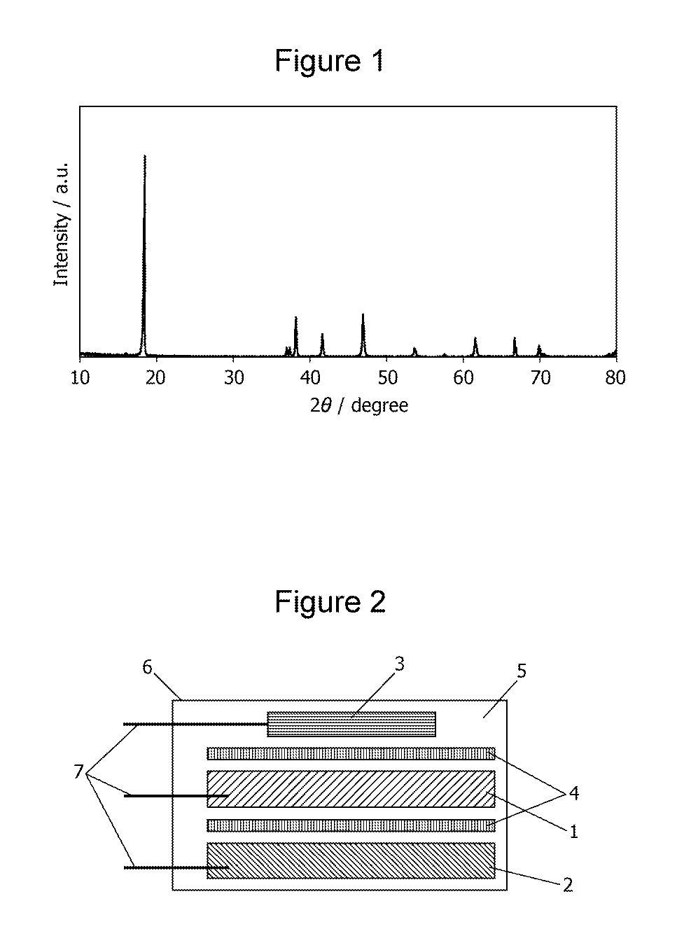

A powder X-ray diffraction pattern of the lithium composite oxide. Al was measured with a powder X-ray diffractometer (product name “RINT2200” manufactured by Rigaku Corporation, radiation source Cu-Ku.). The powder X-ray diffraction pattern of the lithium composite oxide Al is shown in FIG. 1. The powder X-ray diffraction pattern was analyzed to determine the crystal structure. As a result of the analysis, the crystal structure of the lithium composite oxide Al was found to be an O2 structure belonging to the space group P6₃mc.

The composition of the lithium composite Oxide it was determined with an lOP spectrometer (product name “iCAP6300” manufactured by Thermo Fisher Scientific). As a result, the composition of the lithium composite oxide Al was found to be Li_{0.0896}Na_{0.039}Co_{0.914}Mn_{0.086}O₂. Useable 1 describes the proportions of the metal elements constituting the lithium composite oxide Al.

### [Fabrication of Test Cell B1]

A test cell B1 illustrated in FIG. 2 was fabrica in accordance with the following procederes.

The lithium composite oxide Al as a positive electrode active material, acetylene black as a conductive material, and polyvinylidene fluoride as a binder were mixed together so that the electrode active material;conductive material:binder mass ratio would be 80:10:10. The mixture was slurried in N-methyl-2-pyrrolidone. Next, the slurry was applied onto an aluminum foil current collector as a positive electrode current collector, and was dr vacuum at 110° C. A working electrode 1 (a positive electrode) was thus formed.

In dry air having a dew point of not more than -50° C., a test cell B1 that was a nonaqueous electrolyte secondary battery was fabricated using the working electrode a counter electrode 2 (a negative electrode), a reference electrode 3, separators 4, a nonaqueous electrolyte 5, an exterior case 6 for accommodating these: components, and electrode tabs 7 to he attached to the respective electrodes. Details of the constituent elements are described below.

Counter electrode 2: lithium metal

Reference electrode 3: lithium metal

Separators 4: polyethylene separators

Nonaqueous electrolyte 5: The nonaqueous electrolyte

was prepared by dissoiving LiPF₆ as an electrolyte salt into a no aqueous solvent including 4-fluoroethylene carbonate (FEC) and methyl 3,3,3-trifluoropropionate (FMP) in a volume ratio of 20:80. The concentration was 1.0 mol/l.

### Example 2

A lithium composite oxide A2 having a composition described in Table 1 was prepared in the same manner as in EXAMPLE 1, except that LiOH and LiCl were mixed together in a molar ratio of 1:5. A test cell B2 was fabricated using the lithium composite oxide A2.

### Example 3

A lithium composite oxide A3 having a composition described in Table 1 was prepared in the same manner as in EXAMPLE 1, except that LiOH and LiCi were mixed together in a molar ratio of 1:1 and that the amount of Li was set to be 6 times greater than the amount of Na in the sodium composite oxide. A test cell B3 was fabricated using the

lithium composite oxide A3.

### Comparative Example 1

A lithium composite oxide Xi having a composition described in Table 1 was prepared in the same manner as in EXAMPLE I, except that LiOR and LiGI were mixed together in a molar ratio of 1:1. A test cell Y1 was fabricated using the lithium composite oxide X1.

### Comparative Example 2

A lithium composite oxide X2 having a composition described in Table I was prepared in the same manner as in COMPARATIVE EXAMPLE 1, except that the BET specific surface area of the sodium composite oxide was 0.12 m²/g. A test cell Y2 was fabricated using the lithium composite oxide X2.

### Comparative Example 3

A lithium composite oxide X3 having a composition described in Table I was prepared in the same manner as in COMPARATIVE EXAMPLE 1, except that the ion exchange treatment time was 24 hours. A test cell Y3 was fabricated using the lithium composite oxide

### [Evaluation of BET Specific Surface Area (BET Value)]

The PET specific surface area of the lithium composite oxides prepared in EXAMPLES and COMPARATIVE EXAMPLES was measured by a BET method using a nitrogen adsorption-desorption BET specific surface area analyzer (product name “ADSOTRAC DN400” manufactured by NIKKISO CO., LTD.). The evaluation results are described in Table 1.

### [Evaluation of Initial Charge-Discharge Efficiency]

The test cells fabricated in EXAMPLES and COMPARATIVE EXAMPLES were charged and discharged under the following conditions (45° C.) to determine the charge capacity and the discharge capacity per unit weight of the positive electrode active material. The initial charge-discharge efficiency was calculated. The evaluation results are described in Table 1.

Initial charge-discharge efficiency (%)=(Discharge capacity/Charge capacity)×100

The test cells were charged at a constant current of 0.2 it until the positive electrode potential reached 4.55 V (vs. Li/Li) or 4.5 V (vs. Li/Li⁺), and were thereafter discharged at a constant current of 0.2 It until the positive electrode potential reached 3.0 V (v. Li/Li⁺)

TABLE 1

| | Composition of lithium | | | | BET | Initial charge- | |
|---|---|---|---|---|---|---|---|
| | composite oxide | | | | value | discharge efficiency | |
| | Li | Na | Co | Mn | (m²/g) | 4.65 V | 4.5 V |
| EX. 1 | 0.896 | 0.039 | 0.914 | 0.086 | 0.280 | 95.6 | 97.0 |
| Ex. 2 | 0.899 | 0.028 | 0.917 | 0.083 | 0.352 | 98.0 | — |
| Ex. 3 | 0.885 | 0.036 | 0.916 | 0.084 | 0.570 | 95.0 | — |
| COMP. | 0.865 | 0.046 | 0.916 | 0.084 | 0.634 | 94.3 | — |
| EX. 1 | | | | | | | |
| COMP. | 0.926 | 0.028 | 0.917 | 0.083 | 0.728 | 94.1 | — |
| EX. 2 | | | | | | | |
| COMP. | 0.888 | 0.023 | 0.916 | 0.084 | 0.838 | 92.9 | 96.2 |
| EX. 3 | | | | | | | |

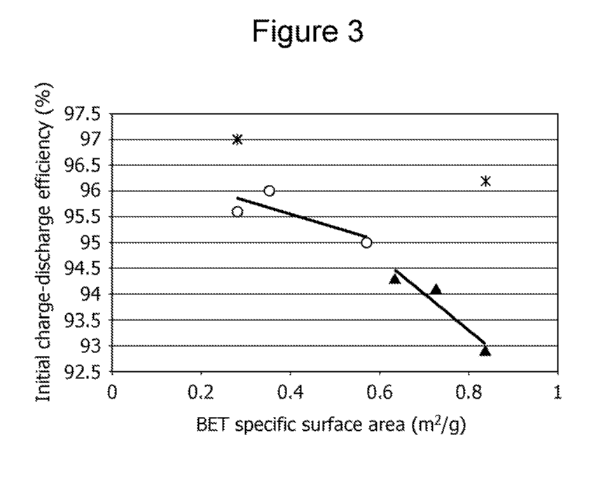

FIG. 3 shows relationships between the BET specific surface area and the initial charge/discharge efficiency of the test cells. In FIG. 3, ◯ represents the data of the test cells of EXAMPLES, ▴ the data of the test cells of COMPARATIVE EXAMPLES, and * the data taken at 4.5 V of the charge cutoff potential of the positive: electrode.

As well understood from FIG. 3, the test cells of EXAMPLES tested at the charge cutoff potential of the positive electrode of above 4.5 V (vs. Li/Li⁺) achieved higher initial charged/discharge efficiency than the test cells of COMPARATIVE EXAMPLES. When, on the other hand, the charge potential was not more than 4.5 V (vs. Li/Li), the test cells of EXAMPLES and those of COMPARATIVE EXAMPLES were similar in initial charge-discharge efficiency. That is, when the charge potential is not more than 4.5 V (vs. Li/Li⁺), there is no threshold value of RET specific surface area which causes a significant change in initial charge-discharge efficiency.

When, in contrast, the charge potential is above 4.5 V (vs. Li/Li⁺), the initial charge-discharge efficiency at such a high potential comes to change significantly on the threshold of 0.6 m²/g of the BET specific surface area of the lithium composite oxide. In detail, the initial charge-discharge efficiency at such a high potential is specifically improved by limiting the BET specific surface area of the lithium composite oxide to below 0.6 m²/g.

When the BET specific surface area of the lithium composite oxide is less than 0.6 m²/g, the change in initial charge-discharge efficiency with the variation in BET specific surface area is small. When, on the other hand, the BET specific surface area is 0.6 m²/g and above, the initial charge-discharge efficiency is significantly changed with the variation in BET specific surface area. That is, the test cells of EXAMPLES attain stable battery performance as compared to the test cells of COMPARATIVE EXAMPLES even in the presence of variations in the BET specific surface area of the positive electrode active: material due to factors such as production errors.

### INDUSTRIAL APPLICABILITY

The present invention may be applied to secondary batteries.

### REFERENCE SIGNS LIST

1 WORKING ELECTRODE

2 COUNTER ELECTRODE

3 REFERENCE ELECTRODE

4 SEPARATOR

5 NONAQUEOUS: ELECTROLYTE

6 EXTERIOR CASE

7 ELECTRODE TAB

1. A nonaqueous electrolyte secondary battery comprising a positive electrode active material including as a main component a lithium composite oxide containing at least cobalt, the lithium composite oxide having a crystal structure belonging to the space group P6₂mc and categorized as an O2 structure,
the BET specific surface area of the lithium composite oxide being less than 0.5
the charge cutoff potential of a positive electrode including the positive electrode active material being lighter than 4.5 V (vs. Li/Li⁺).

2. The nonaqueous electrolyte secondary battery according to claim 1, wherein the lithium composite oxide is represented by the general formula: LiₓNa_{y}Co_{z}M_{(1-z)}O_{(2±y)} {0.75<x<1.1, 0 <y<0.1, 0.8<z<0.98, 0≦γ<0.1, and M is at least one metal element (except Li, Na and Co)}.

3. The nonaquous electrolyte secondary battery according to claim 1, wherein the lithium composite oxide is represented by the general formula: LiₓNa_{y}Co_{z1}Mn_{z2}M_{(1-z1-z2)}O_{(2±y)}{0.75<x<1.1, 0<y<0.1, 0.8<z1≦0.98, 0<z2≦0.2, 0≦γ<0.1, and M is at least one metal element (except Li, Na, Go and Mn)}.
